(19) United States
(12) Patent Application Publication
(10) Pub. No.: US 2011/0265005 A1
(43) Pub. Date: Oct. 27, 2011

(54) METHOD, SYSTEM AND APPARATUS FOR MANAGING MESSAGE ATTACHMENTS

(75) Inventors: Ming Zhao, Markham (CA); Hong Albert Cai Wang, Toronto (CA); Rakesh Kumar ARORA, Burlington (CA)

(73) Assignee: RESEARCH IN MOTION LIMITED, Waterloo (CA)

(21) Appl. No.: 12/765,416

(22) Filed: Apr. 22, 2010

(51) Int. Cl. G06F 3/048

(52) U.S. Cl. 715/732; 715/748

(57) ABSTRACT

According to embodiments described in the specification, a method, system and apparatus for managing attachments are provided. The method comprises: receiving a request for a slideshow attachment, the slideshow attachment maintained in a memory; distilling at least one content layer from the slideshow attachment; generating a slide list from the slideshow attachment; converting the slide list and at least a portion of the at least one content layer into a transmission format; and, transmitting a response to the request, the response comprising the converted slide list and the converted portion of the at least one layer.

### FIELD

The specification relates generally to message attachments, and specifically to a method, system and apparatus for managing message attachments.

### BACKGROUND

As the usage of mobile electronic devices, such as smart phones, continues to grow, so do the demands for increased functionality imposed on such devices. While the capabilities of these devices also increase, their computational, memory and bandwidth resources continue to be limited in comparison to mains-powered computing devices.

### BRIEF DESCRIPTIONS OF THE DRAWINGS

Embodiments are described with reference to the following figures, in which:

FIG. 1 depicts a system for managing message attachments, according to a non-limiting embodiment;

FIG. 2 depicts a method of managing a slideshow attachment, according to a non-limiting embodiment;

FIG. 3 depicts a performance of a portion of the method of FIG. 2 on the system of FIG. 1, according to a non-limiting embodiment; and

FIG. 4 depicts a schematic diagram of content layers generated in the system of FIG. 1, according to a non-limiting embodiment;

FIG. 5 depicts a schematic diagram of a slide list generated in the system of FIG. 1, according to a non-limiting embodiment;

FIG. 6 depicts a performance of a further portion of the method of FIG. 2 on the system of FIG. 1, according to a non-limiting embodiment;

FIG. 7 depicts a schematic representation of a slide from a slideshow attachment, according to a non-limiting embodiment; and

FIG. 8 depicts a method of managing a slideshow attachment, according to another non-limiting embodiment.

### DETAILED DESCRIPTION OF THE EMBODIMENTS

According to an aspect of the specification, a method of managing attachments is provided. The method comprises receiving a request for a slideshow attachment, the slideshow attachment maintained in a memory; distilling at least one content layer from the slideshow attachment; generating a slide list from the slideshow attachment; converting the slide list and at least a portion of the at least one content layer into a transmission format; and, transmitting a response to the request, the response comprising the converted slide list and the converted portion of the at least one layer.

According to another aspect of the specification, a server is provided, comprising a memory for storing a slideshow attachment; a communications interface for receiving a request for the slideshow attachment; and a processor interconnected with the memory and the communications interface, the processor configured to receive the request via the communications interface, to distill at least one content layer from the slideshow attachment; to generate a slide list from the slideshow attachment; to convert the slide list and at least a portion of the at least one content layer into a transmission format; and to transmit a response to the request via the communications interface, the response comprising the converted slide list and the converted portion of the at least one layer.

According to a further aspect of the specification, a computer readable storage medium is provided, for storing computer readable instructions for execution by a processor. The computer readable instructions implement a method comprising receiving a request for a slideshow attachment, the slideshow attachment maintained in a memory; distilling at least one content layer from the slideshow attachment; generating a slide list from the slideshow attachment; converting the slide list and at least a portion of the at least one content layer into a transmission format; and, transmitting a response to the request, the response comprising the converted slide list and the converted portion of the at least one layer.

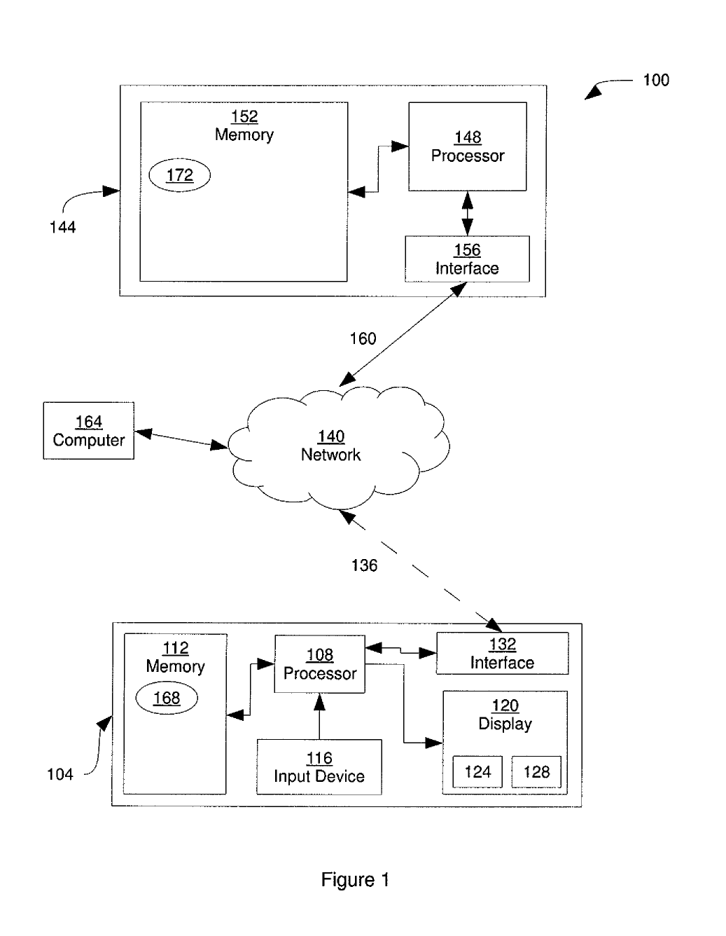

FIG. 1 depicts a communications system 100 for managing attachments. System 100 includes a mobile electronic device 104, which in the present embodiment is based on the computing environment and functionality of a hand-held wireless communication device. It will be understood, however, that mobile electronic device 104 is not limited to a hand-held wireless communication device. Other mobile electronic devices are possible, such as cellular telephones, smart telephones, Personal Digital Assistants (“PDAs”), media or MP3 players, laptop computers and the like. Mobile electronic device 104 includes a processor 108 interconnected with a memory 112. Memory 112 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. Mobile electronic device 104 also includes one or more input devices 116 interconnected with processor 108. Input device 116 is generally configured to provide input data to processor 108 and can include any suitable combination of keypads, microphones, touch screens and the like. Mobile electronic device 104 also includes one or more output devices, such as a display 120. It will be appreciated that other output devices are also contemplated, such as a speaker (not shown), a light-emitting indicator such as a Light Emitting Diode (LED) (not shown) and the like. Display 120 includes display circuitry 124 controllable by processor 108 for generating representations 128 of data and/or applications maintained in memory 112. It will now be apparent that display 120 can include a flat panel display (e.g. Liquid Crystal Display (LCD), plasma, and the like), a Cathode Ray Tube (CRT), and the like. It will also now be apparent that a touch screen input device can be integrated with display 120.

Mobile electronic device 104 also includes a communications interface 132 interconnected with processor 108. Communications interface 132 allows mobile electronic device 104 to communicate with other computing devices via a link 136 and a network 140. Network 140 can include any suitable combination of wired and/or wireless networks, including but not limited to a Wide Area Network (“WAN”) such as the Internet, a Local Area Network (“LAN”), cell phone networks, WiFi networks, WiMax networks and the like. Link 136 is compatible with network 140. In particular, link 136 can be a wireless link based on Global System for Mobile communications (“GSM”), General Packet Radio Service (“GPRS”), Enhanced Data rates for GSM Evolution (“EDGE”), and the third-generation mobile communication system (3G), Institute of Electrical and Electronic Engineers (“IEEE”) 802.11 (WiFi) or other wireless protocols. It will be understood that link 136 also includes any base stations and backhaul links necessary to connect mobile electronic device 104 to network 140. It will be understood that communications interface 132 can therefore be selected for compatibility with link 136 as well as with network 140.

The various components of mobile electronic device 104 are interconnected, for example via a communication bus (not shown). Mobile electronic device 104 can be powered by a battery (not shown).

System 100 also includes a server 144, which can be based on any known server environment. As such, server 144 includes a processor 148 interconnected with a memory 152 which can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. Server 144 also includes a communications interface 156 interconnected with processor 148. Communications interface 156 allows server 144 to communicate with other computing devices via a link 160 and network 140. Link 160 can be, for example, a wired link.

Server 144 can be managed by way of input and output devices (not shown) such as a keyboard and a display. Such input and output devices can be co-located with server 144 or can be located at a terminal (not shown) remote from server 144.

In general, mobile electronic device 104 can receive communications—such as e-mail messages, Short Message Service (SMS), or text, messages, Multimedia Message Service (MMS) messages, and the like—from other computing devices such as personal computer 164. It will be understood that a wide variety of other computing devices are also contemplated, including other mobile electronic devices (not shown). Such communications can be received, via network 140, at communications interface 132. Processor 108 can be configured, by execution of one or more messaging applications (not shown) maintained in memory 112, to render representations of the communications on display 120. As will be appreciated by those skilled in the art, some communications can include attachments. For example, e-mail messages sent by other computing devices can include attachments such as word processing documents, images, slideshows and the like. Server 144 can be an attachment server, acting as an intermediate between the other computing devices and mobile electronic device 104. In particular, e-mail messages containing attachments can be delivered to mobile electronic device 104 with an indication that an attachment is available, rather than the attachment itself. Mobile electronic device 104 can then request the attachment from server 144 in order to obtain and display the attachment.

Mobile electronic device 104 can therefore include an attachment viewer application 168 maintained in memory 112. Server 144 can also maintain an attachment handler application 172 in memory 152. Attachment viewer application 168 and attachment handler application 172 can each comprise computer readable instructions for execution by processors 108 and 148, respectively. In general, processors 108 and 148 can be configured, by execution of attachment viewer application 168 and attachment handler application 172 respectively, to perform various tasks as discussed below.

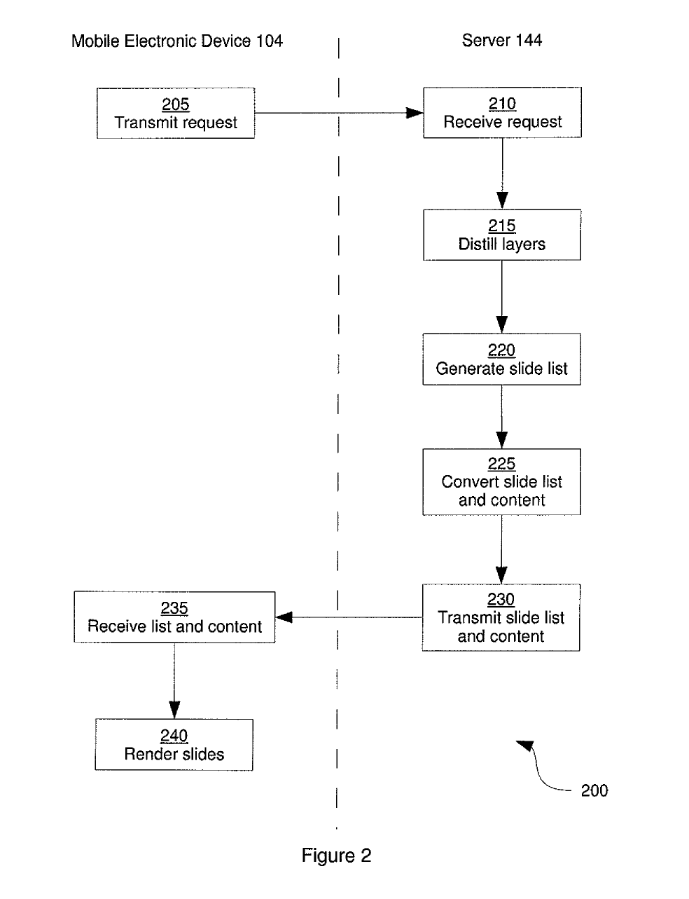

Turning to FIG. 2, a flowchart of a method 200 of handling a slideshow attachment is depicted. Method 200 will be discussed in conjunction with its performance in system 100, though it will be understood that method 200 need not be performed solely on system 100. It will be appreciated that prior to the performance of method 200, mobile electronic device 104 can have received a communication, such as an e-mail message, including an indication that a slideshow attachment is available at server 144.

At block 205, processor 108 can be configured via execution of attachment viewer application 168 to transmit, via communications interface 132, a request for the slideshow attachment to server 144. It will now be apparent that performance of block 205 can be initiated following receipt of input data at input device 116 indicating that the request should be transmitted.

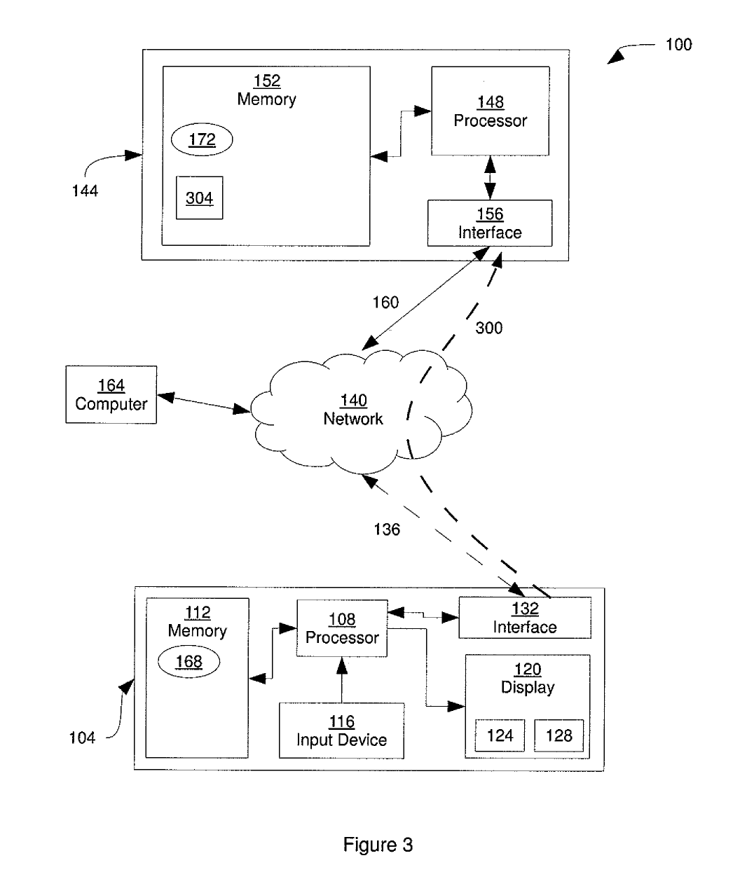

At block 210, processor 148 of server 144 is configured, via execution of attachment handler application 172, to receive the request via communications interface 156. Referring briefly to FIG. 3, performance of blocks 205 and 210 are depicted by path 300, with a request being transmitted from communications interface 132, via network 140, to communications interface 156. Also depicted in FIG. 3 is a slideshow attachment 304 maintained in memory 152 of server 144.

Returning to FIG. 2, following receipt of the request at block 210, processor 148 is configured to perform block 215. At block 215, processor 148 can be configured to distill a plurality of content layers from slideshow attachment 304.

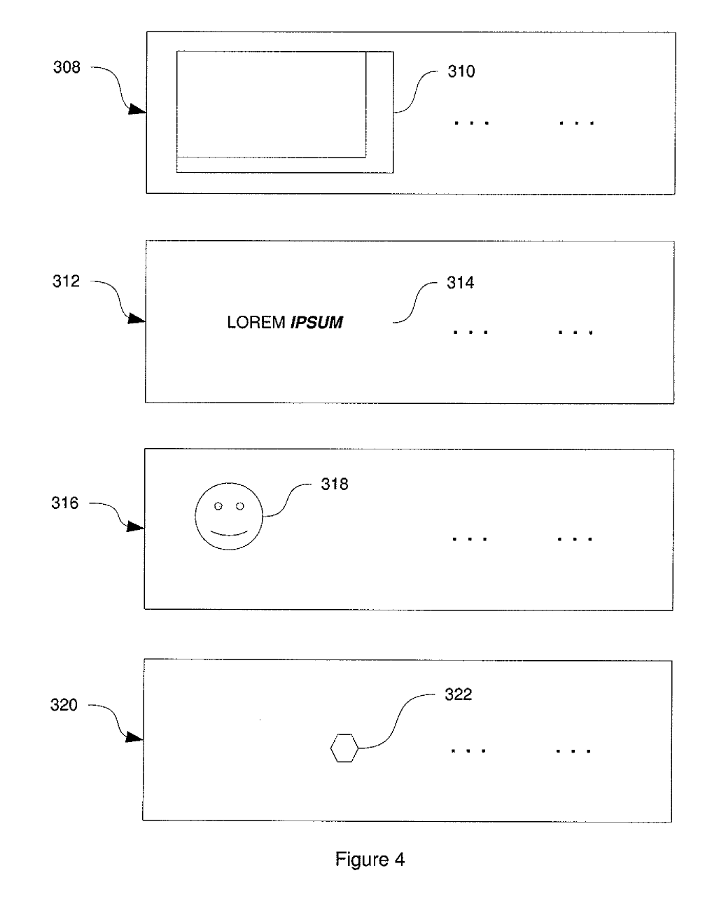

In some embodiments, processor 148 can be configured, via execution of attachment handler application 172, to distill four content layers from slideshow attachment 304. Referring now to FIG. 4, the four layers will be described in greater detail.

A master layer 308 can contain data describing the background, style and layout of each slide. Master layer 308 is thus depicted in FIG. 4 as containing a background 310 for a slide. It will now be apparent to those skilled in the art that master layer 308 can contain any number of slide backgrounds, layouts and the like. For instance, if three different backgrounds are used throughout slideshow attachment 304, master layer 308 would contain two other backgrounds in addition to background 310. That is, processor 148 can be configured to traverse slideshow attachment 304 and for each new (that is, not already stored in master layer 308) item of master data (background, style, layout and the like), to store the new item of master data within master layer 308.

A text layer 312 contains the text for each slide in slideshow attachment 304. In distilling text layer 312, processor 148 can traverse each slide in slideshow attachment 304 in order to detect text elements. For each slide where text elements exist, processor 148 can be configured to generate an image of the text elements based on attributes of the text elements specified within slideshow attachment 304. Generation of an image allows for more accurate reproduction of the text in slideshow attachment 304, for example when slideshow attachment 304 contains fonts, languages or other text attributes that may not be recognized by mobile electronic device 104. In FIG. 4, exemplary text layer 312 contains an image 314 of the text element “LOREM IPSUM.” The appearance of the text in image 314 is determined by attributes within slideshow attachment 304 detected by processor 148, such as font, font size, colour and the like. For instance, it can be seen in FIG. 4 that the second word of text in image 314 is bolded and italicized as a result of attributes within slideshow attachment 304. Image 314 can be in a format capable of specifying transparency attributes, such as the Portable Network Graphics (PNG) format.

It will be understood that while only a single image of text is shown in text layer 312 for exemplary purposes, text layer 312 can contain any number of images. In some embodiments, text layer 312 contains one image for each slide within slideshow attachment 304 that contains new text elements (that is, a text element or combination or text elements that are not already represented by an image in text layer 312).

An object layer 316 contains images, charts, animation effects and the like within slideshow attachment 304. Processor 148 can thus be configured to traverse slideshow attachment 304 and to add each new object (that is, an object not already stored in object layer 316) to object layer 316. FIG. 4 shows an image 318 stored in object layer 316, though it will be appreciated that any number of images and other objects can be stored within object layer 316.

An action layer 320 contains links, buttons and the like that, for example, jump to other slides in slideshow attachment 304. As with the previous layers, processor 148 can be configured, via execution of attachment handler application 172, to traverse slideshow attachment 304 and add each new action element (that is, any action element that is not already present in action layer 320) to action layer 320. In FIG. 4, a button 322 is stored in action layer 320. As will now be apparent, any number of action elements can be stored in action layer 320.

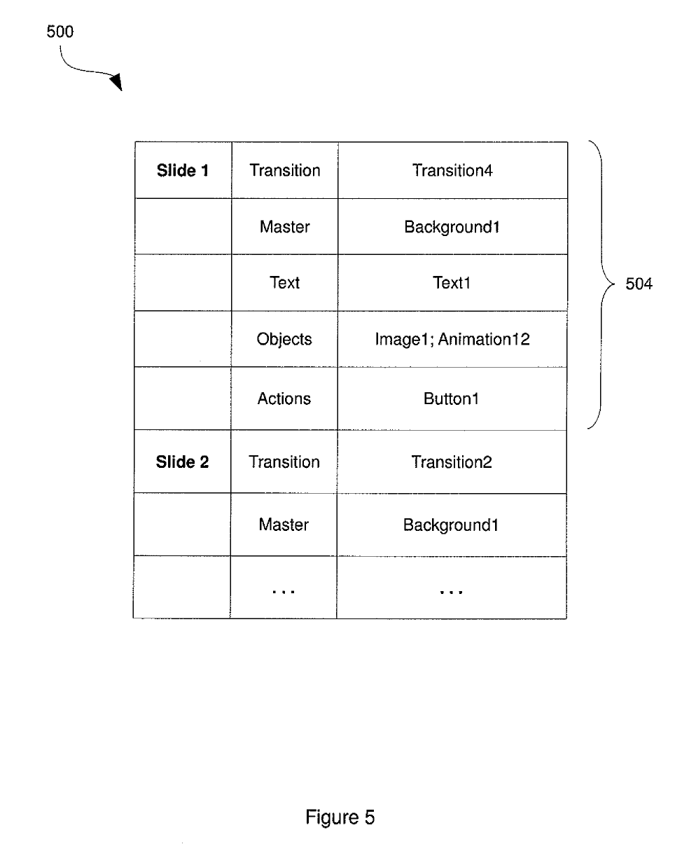

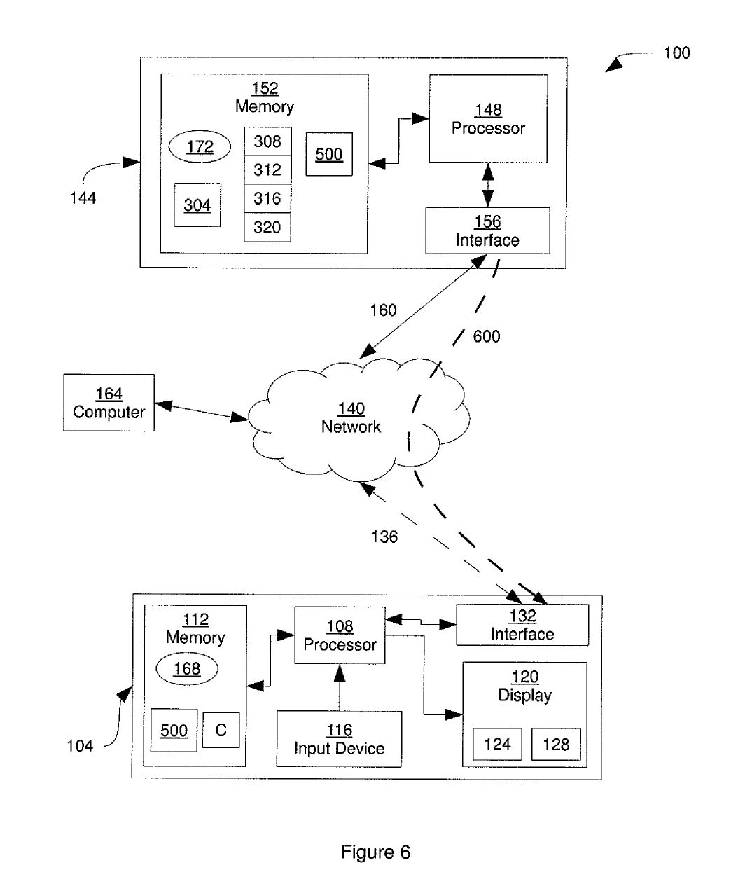

Upon completion of block 215, the distilled layers of slideshow attachment 304 can be maintained in memory 152 of server 144, as shown in FIG. 6. Returning briefly to FIG. 2, following completion of block 215, processor 148 of server 144 can be configured to perform block 220. At block 220, a slide list is generated from slideshow attachment 304. An exemplary slide list 500 is shown in FIG. 5. In general, slide list 500 provides a reference list with which to reconstruct the slides of slideshow attachment 304 from the content in layers 308, 312, 316 and 320.

Slide list 500 can comprise one or more entries 504 for each slide in slideshow attachment 304. Each entry 504 can contain an indication of an item of content from the layers distilled at block 215. For example, entries 504 of slide list 500 include a “Transition” attribute entry containing an indication of which transition effects are to be used between “Slide 1” and the next slide (such as animations, sounds and the like, if any), as well as one entry for each type of content (“type” being based on which layer the content falls into). It will now be apparent that processor 108 can be configured, via execution of attachment viewer application 168, to detect the transition identifier attribute and implement the corresponding transition effect(s). Attachment viewer application 168 can, in some embodiments, include a transition package containing the necessary data for implementing the transition effects that can be specified in slide list 500. Attachment handler application 172 can include a counterpart transition package for configuring processor 148 to recognize transition effects in slideshow attachment 304 and provide corresponding indicators in slide list 500.

The remaining ones of entries 504 include a master entry, a text entry, an object entry and an actions entry. It will be understood that additional attributes (not shown) can also be specified in slide list 500. The master entry includes an indication of which background image (“Background1”) from master layer 308 to use for the first slide of slideshow attachment 304. The text, objects and actions entries likewise contain indications of which items of content from their respective layers are to be used in rendering the first slide of slideshow attachment 304. As can be seen in FIG. 5, a set of entries as described above can be included for each slide in slideshow attachment 304. As will now be apparent, in some embodiments only a single entry can be included for each slide. The single entry can contain all the indications shown in entries 504. It will also be appreciated that contents within the layers distilled at block 215 can be reused by different slides in slideshow attachment 304. For example, Slide 1 and Slide 2 in slide list 500 both include indications that “Background1” is to be used from master layer 308. Thus, where an element of content is duplicated across a plurality of slides in slideshow attachment 304, the corresponding one of layers 308, 312, 316 and 320 need only contain one copy of that element. It will also be understood that not every slide need contain indicators in every entry of slide list 500. For example, a given slide may not make use of any transition effects, in which case no indication would be provided in the transition entry for that slide. As a further example, some slides may not contain any text, in which case, in which case the text entries for those slides would be empty.

In order to generate slide list 500, processor 148 can be configured to traverse slideshow attachment 304 and, for each slide therein, to store in an entry 504 indicators corresponding to the elements constituting the slide. It will be appreciated that generation of slide list 500 at block 220 can, in some embodiments, be performed substantially simultaneously with the distilling of layers at block 215. For example, having identified new text elements in a slide, processor 148 can distill those text elements into image 314 as seen in FIG. 4 and store the indicator “Text1” identifying image 314 in the text entry of slide list 500, prior to examining slideshow attachment 304 for further content or for other types of content.

Once the generation of slide list 500 has been completed at block 220, slide list 500 can be maintained in memory 152 of server 144, as shown in FIG. 6.

Referring again to FIG. 2, performance of method 200 continues at block 225. At block 225, processor 148 can be configured to convert slide list 500 and at least a portion of at least one of the layers distilled at block 215 to a format suitable for transmission to mobile electronic device 104 over network 140. In some embodiments, the Universal Content Stream (UCS) format can be used. Other suitable formats will also occur to those skilled in the art.

Proceeding then to block 230, processor 148 can be configured to transmit, via communications interface 156, the converted slide list and the converted content to mobile electronic device 104. At block 235, processor 108 of mobile electronic device can be configured to receive, via communications interface 132, the slide list and content transmitted from server 144 at block 230. Following receipt of slide list 500 and the converted content portion at block 235, processor 108 can be configured to store slide list 500 and the content (shown as “C” in FIG. 6) in memory 112. Performance of blocks 230 and 235 is shown in FIG. 6 by path 600.

Referring back to FIG. 2, having received slide list 500 and the content portion at block 235, processor 108 can be configured, via execution of attachment viewer application 168, to render the slides of slideshow attachment 304 at block 240. Performance of block 240 can include controlling display circuitry 124 to generate representations 128 of one or more slides on display 120. Performance of block 240 can also include controlling display circuitry 124 to generate representations on an external display (not shown) such as a projector to which mobile electronic device 104 can be connected by, for example, a Universal Serial Bus (USB) link, a Bluetooth link and the like.

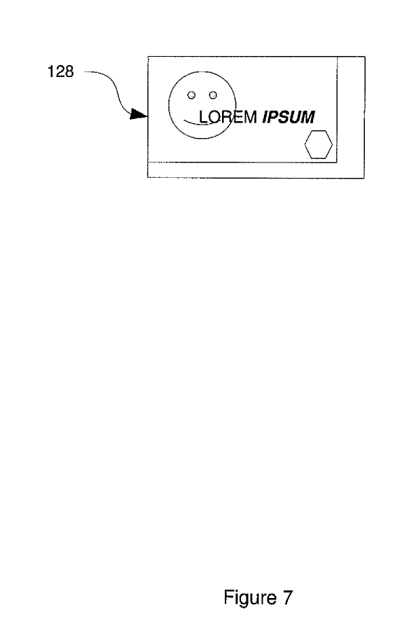

Turning to FIG. 7, a representation 128 of the first slide in slideshow attachment 304 is depicted, as rendered on display 120 of mobile electronic device 104. As can be seen in FIG. 7, representation 128 combines the items of content specified in slide list 500 for slide 1: “Background1” (which can be background 310), “Text1” (which can be image 314 from text layer 312), “Image 1” (which can be image 318) and “Buttonl” (which can be button 322). It will now be apparent that additional elements and attributes specified in slide list 500, such as animations and transitions, can also be displayed in representation 128, though they are not shown in FIG. 7. Each of the above-referred to elements can be superimposed on each other to render the slide.

Following completion of block 240, it will be appreciated that mobile electronic device 104 can receive, via input device 116, input data indicative of a request for additional slides. Processor 108 can be configured to determine whether the content for such additional slides (as specified by slide list 500) exists within memory 112. If such additional content does not exist within memory 112, processor 108 can be configured to transmit a “More” request to server 144. Having received the request, server 144 can then convert and transmit additional content as at blocks 225 and 230 of method 200.

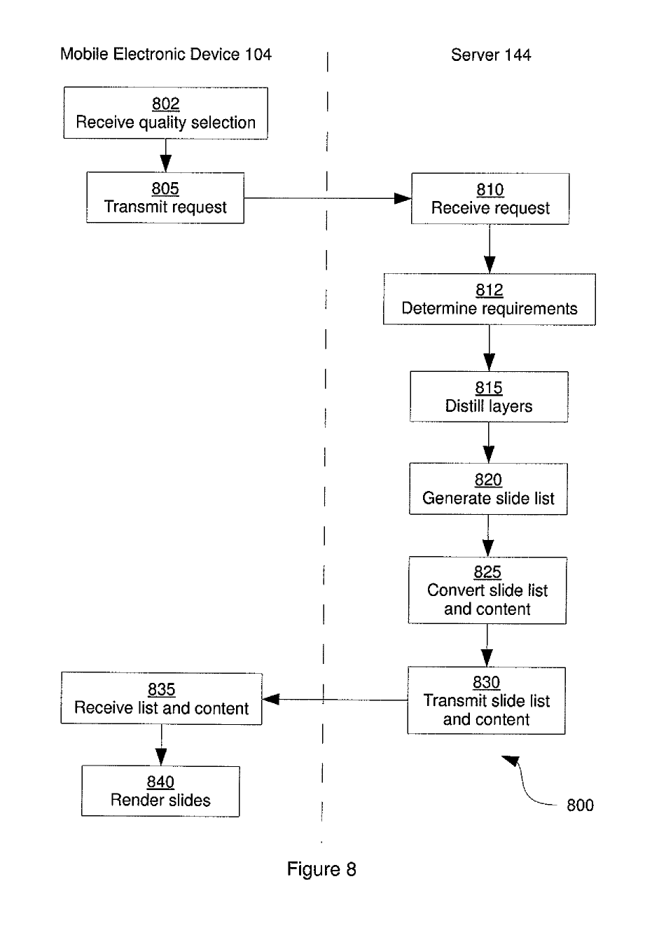

In some embodiments, the request for slides from mobile electronic device 104 can include additional indicators that affect the distilling of slideshow attachment 304 into layers. Turning to FIG. 8, a method 800 of managing a slideshow attachment is depicted.

Method 800 begins at block 802, at which processor 108 of mobile electronic device can be configured, via execution of attachment viewer application 168, to receive input data indicative of a quality selection. Receipt of such a selection can follow the display, via control of display circuitry 124, of selectable options for “high” or “normal” quality. As will be appreciated, other options are also contemplated. Following receipt of a quality selection at block 802, method 800 proceeds to block 805. Block 805 is similar to block 205, described above, with the exception that the request transmitted at block 805 includes a quality indicator based on the selection received at block 802.

Server 144 can receive the request at block 810, as discussed above in relation to block 210. Processor 148 of server 144 can be configured to determine, at block 812, the distilling requirements associated with the request. In some embodiments, therefore, processor 148 can be configured to determine the required quality of distilled content. If, for example, the received quality indicator is “high,” processor 148 can distill slideshow attachment 304 at block 815 as discussed above in relation to block 215, but at a higher quality. That is, images and the like generated for layers 308, 312, 316 and 320 can be of a higher resolution, colour depth and the like. For instance, image 314 can be generated at a resolution of 1000 pixels by 700 pixels rather than a lower normal (or “default”) of 300 pixels by 200 pixels. The above resolutions, it will be understood, are purely for exemplary purposes. Any suitable resolutions and other quality parameters can be used. Following distillation of layers at block 815, the performance of blocks 820, 825, 830, 835 and 840 can continue as described above in relation to blocks 220, 225, 230, 235 and 240, respectively.

In some embodiments, the request transmitted at block 805 can contain, in addition to or instead of the quality selection, an indication of the capabilities of mobile electronic device 104. Such an indication can be, for example, a model number of device 104 or a listing of types of content compatible with mobile electronic device 104. For example, mobile electronic device may be unable to process animations. Having received a model number of mobile electronic device 104 at block 810, processor 148 of server 144 can be configured to determine, at block 812, that mobile electronic device 104 cannot process animation objects within slides. Processor 148 can then be configured, at block 815, to distill slideshow attachment 304 into layers, omitting any animations contained within slideshow attachment 304. In other embodiments, processor 148 can be configured to distill all content in slideshow attachment 304, but to omit animations when converting and transmitting content at blocks 825 and 830. It will also be understood that processor 148 can omit indicators referring to animations when generating slide list 500 at block 820.

It will now be apparent that other variations can also be made to the methods and system described herein. For example, in other embodiments, applications 168 and 172 can be maintained on computer readable storage media other than memories 112 and 152. Exemplary computer readable storage media include fixed, tangible storage media readable directly by processors 108 and 148 (e.g., removable diskette, CD-ROM, ROM, fixed disk, USB drive). Other exemplary computer readable storage media include remote storage from which computer readable instructions are transmittable to processors 108 and 148.

Those skilled in the art will appreciate that in some embodiments, the functionality of one or both of attachment viewer application 168 and attachment handler application 172 can be implemented using pre-programmed hardware or firmware elements (e.g., application specific integrated circuits (ASICs), electrically erasable programmable read-only memories (EEPROMs), etc.), or other related components.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A method of managing attachments, the method comprising:
receiving a request for a slideshow attachment, the slideshow attachment maintained in a memory;
distilling at least one content layer from the slideshow attachment;
generating a slide list from the slideshow attachment;
converting the slide list and at least a portion of the at least one content layer into a transmission format; and,
transmitting a response to the request, the response comprising the converted slide list and the converted portion of the at least one layer.

2. The method of claim 1, wherein the transmission format is Universal Content Stream (UCS).

3. The method of claim 1, wherein distilling comprises distilling a master layer, a text layer, an objects layer and an actions layer from the slideshow attachment.

4. The method of claim 3, wherein the master layer comprises at least one of a slide background, a slide layout and a slide style.

5. The method of claim 3, wherein the text layer comprises at least one image of at least one text element.

6. The method of claim 3, wherein the objects layer comprises at least one of an image and an animation.

7. The method of claim 3, wherein the actions layer comprises at least one of a link and a button.

8. The method of claim 1, wherein the request comprises a quality indicator and wherein the method further comprises:
determining a requested quality prior to distilling; and,
distilling based on the determined requested quality.

9. The method of claim 1, wherein the slide list comprises at least one entry, the at least one entry containing an identifier of a content element within the at least one layer.

10. The method of claim 9, wherein the slide list further comprises at least one attribute entry, the at least one attribute entry containing an indication of a transition effect.

11. A server comprising:
a memory for storing a slideshow attachment;
a communications interface for receiving a request for the slideshow attachment; and
a processor interconnected with the memory and the communications interface, the processor configured to receive the request via the communications interface, to distill at least one content layer from the slideshow attachment; to generate a slide list from the slideshow attachment; to convert the slide list and at least a portion of the at least one content layer into a transmission format; and to transmit a response to the request via the communications interface, the response comprising the converted slide list and the converted portion of the at least one layer.

12. The server of claim 11, the processor being configured to distill a master layer, a text layer, an objects layer and an actions layer from the slideshow attachment.

13. The server of claim 12, wherein the master layer comprises at least one of a slide background, a slide layout and a slide style.

14. The server of claim 12, wherein the text layer comprises at least one image of at least one text element.

15. The server of claim 12, wherein the objects layer comprises at least one of an image and an animation.

16. The server of claim 12, wherein the actions layer comprises at least one of a link and a button.

17. The server of claim 11, wherein the request comprises a quality indicator, the processor being further configured to determine a requested quality prior to distilling; and to distill the at least one content layer based on the determined requested quality.

18. The server of claim 11, wherein the slide list comprises at least one entry, the at least one entry containing an identifier of a content element within the at least one layer.

19. The server of claim 18, wherein the slide list further comprises at least one attribute entry, the at least one attribute entry containing an indication of a transition effect.

20. A computer readable storage medium for storing computer readable instructions for execution by a processor, the computer readable instructions implementing a method comprising:
receiving a request for a slideshow attachment, the slideshow attachment maintained in a memory;
distilling at least one content layer from the slideshow attachment;
generating a slide list from the slideshow attachment;
converting the slide list and at least a portion of the at least one content layer into a transmission format; and,
transmitting a response to the request, the response comprising the converted slide list and the converted portion of the at least one layer.
